(19) United States
(12) Patent Application Publication
(10) Pub. No.: US 2017/0222536 A1
(43) Pub. Date: Aug. 3, 2017

(54) Regenerative Energy Generation System (R.E.G.S.)

(71) Applicant: Justin Reese Chrivia, Anderson, IN (US)

(72) Inventor: Justin Reese Chrivia, Anderson, IN (US)

(21) Appl. No.: 15/015,079

(22) Filed: Feb. 3, 2016

(51) Int. Cl. H02K 47/20; H02J 9/06

(52) U.S. Cl. CPC H02K 47/20; H02J 9/061; Y10S 74/09; H02K 53/00

(57) ABSTRACT

A power generating system. The system generates enough energy to allow the processes needed to operate while also generating enough energy for an outside product to operate at capacity to the machine limits by the use of electric motor control(s) and mechanical advantage by utilizing proper gearing with the use of sprockets, pulleys, gears or any combination to create the necessary ratio. The invention utilizes increased electrical motor torque, horsepower and motor control to rotate a power generating unit, causing the power generating unit to produce electricity. A transmission device is coupled between the motor and the power generating unit to increase the torque and horsepower of the motor so as to power the generating unit by gearing, torque, force, and lever force by way of the use of simple machines such as levers and pulleys.

### BACKGROUND OF THE INVENTION

The present invention relates to a power generating system, and more particularly, to such a power generating system, which uses electromechanical manipulation, force, gears, and leverage to increase the overall ability of the electric motor to produce torque and horsepower in order to rotate the rotor of a power generating unit, so as to enhance the electric motor capability while reducing the overall energy consumption to energy creation ratio of the invention as a whole.

Continuous consumption of natural resources (for example, gasoline, natural gas, coal) causes the shortage of said natural resources and contributes to the addition of greenhouse gases to the atmosphere. In order to satisfy the demand for energy, different power generating methods have been developed. These power generating methods use nuclear, thermal, hydraulic, wind, solar, or sea wave power as a form of energy to rotate a rotor on an energy generation device. Therefore, for generating electricity, energy is needed to rotate the rotor of the power generating system. Using an electric motor to drive a power generator to generate electricity has been utilized, however, if the electric motor consumes about 900 watts, the. electric current output of the power generator may be equal to or less than that of the electric motor that drives it because power loss is inevitable during its transmission. A power generator only has industrial value when its electric current output is greater than the power consumption of the motor. In order to deem the output current of the generator as usable power for the motor and any outside needs such as homes and businesses, or even aircraft, trains and electric automobiles a special measure must be employed.

### SUMMARY OF THE INVENTION

It is the main objective of the present invention to provide a power generating system, which uses electrical force, mechanical force, lever force, and motion controls to enhance the ability of the torque produced by a motor, so as to decrease the energy needed to be consumed to rotate the power-generating unit. To the objectives of the present invention, the power generating system comprises of an uninterruptable power supply (UPS) or power transfer/switching method, a variable frequency drive (VFD) or motor control, an electric motor smaller in horsepower or energy consumption than the rated wattage and amperage output of the electricity generator, a torque multiplier coupled to and rotated by the motor, a set of pulleys, gears or sprockets that when coupled will rotate the generator at its optimal speed all of which is coupled to or between the motor and power generating unit.

### DETAILED DESCRIPTION OF THE PREFERRED EMBODIMENT

The power generating system of the present invention has industrial value and can be used in electric cars, electric motorcycles, electric trains, etc. However, it is to be understood that the drawings are designed for purposes of illustration only, and are not intended for use as a definition of the limits and scope of the invention disclosed.

Referring to FIGS. 1.0 through 5.0, the present invention uses electrical and mechanical energy to optimize the horsepower and torque of an electric motor (1.3) enabling a power generating unit (1.6) to output enough energy for the electric motor (1.3), motor control (1.2) , power transfer/switching method (1.1), and any losses associated with said equipment while also allowing for excess energy to be produced by the power generating unit (1.6) to supply energy to homes, businesses, aircraft, locomotives, and automobiles including motorcycles and scooters. The prime power source of the Regenerative Energy Generating System is the electric motor (1.3); a torque multiplier (1.4) is connected to the output shaft (1.3a) of the electric motor (1.3) the torque multiplier (1.4) is gear, pulley, or magnet driven. On the output shaft (1.4a) of the multiplier (1.4) is affixed one or more pulley, sprocket or gear (1.5) and another is affixed to the output shaft (1.6a) of the electric generator (1.6) as to create the needed rotations per minute (rpm) to rotate the electric generator (1.6) at an optimal speed and are connected via belt or chain or directly for gear driven purposes. The generator (1.6) is connected by electrical wire or cable (1.F) to the uninterruptable power supply (UPS) (1.0) as to allow for the flow of electrical current. The UPS (1.0) consists of batteries and/ or capacitors for storing electrical energy, a charging method to restore consumed energy back to the batteries and/or capacitors, a direct current (DC) to alternating current (AC) converter to change the stored DC electrical current into usable AC electrical current if AC is the desired outcome or an AC to DC converter if DC is the desired outcome or both; and circuitry to allow for the transfer of energy either from the UPS (1.0) or the main power supply in which under normal operating conditions is the generator (1.6). The UPS-power transferring circuit (1.0) is connected by electrical wire or cable to the variable frequency drive (VFD also known as an electric motor control) (1.2) The VFD (1.2) corrects the phase of the incoming current and supplies the motor (1.3) with the necessary voltage, frequency and amperage to run at the optimal level.

To start the process, energy that is stored in the UPS (1.1) is released to the VFD (1.2). The VFD (1.2) is energized and energy is released to the electric motor (1.3) as to allow for rotation. The energy allowed to the motor (1.3) is increased until the output shaft (1.6a) of the electric generator (1.6) reaches its optimal speed to produce electricity. The electricity flows from the generator (1.6) into the UPS (1.0) at which point the current from the UPS stored energy (1.0) is switched off if desired or left on to continue a circuit and the current from the generator (1.6) is switched on-creating a closed circuit. Energy can now be drawn from the generator and/or the stored power at the battery(s) to also power one or more products so long as they do not draw more energy than the UPS, VFD, and electric motor need to operate at the necessary operating ratings.

### BRIEF DESCRIPTION OF THE DRAWINGS

FIG. 1.0 Illustrates the arrangement of the power generating system according to the present invention. The numbers following are all referring to FIG. 1.0 and go in order from 1.1 through 1.6 and 1.F

FIG. 1.1 Illustrates the arrangement of the uninterruptable power supply (UPS) unit and the power transmission unit according to the present invention.

FIG. 1.2 Illustrates the arrangement of the variable frequency drive (VFD) according to the present invention.

FIG. 1.3 Illustrates the arrangement of the electric motor according to the present invention.

FIG. 1.3a Illustrates the output shaft of the electric motor.

FIG. 1.4 Illustrates the arrangement of the torque multiplier according to the present invention.

FIG. 1.4a Illustrates the output shaft of the torque multiplier.

FIG. 1.5 Illustrates the arrangement of the pulley or sprocket set according to the present invention.

FIG. 1.6 Illustrates the arrangement of the electric generator according to the present invention.

FIG. 1.6a Illustrates the output shaft of the electric generator.

FIG. 1.F Illustrates the process flow to create a closed circuit.

FIG. 2.0 Illustrates the electrical flow in varying scenarios.

FIG. 3.0 Illustrates the electrical flow in varying scenarios.

FIG. 4.0 Illustrates a plausible power converting motor control and plausible method of a phase converter.

FIG. 5.0 Illustrates an explanation of the math during differing parts of the process.

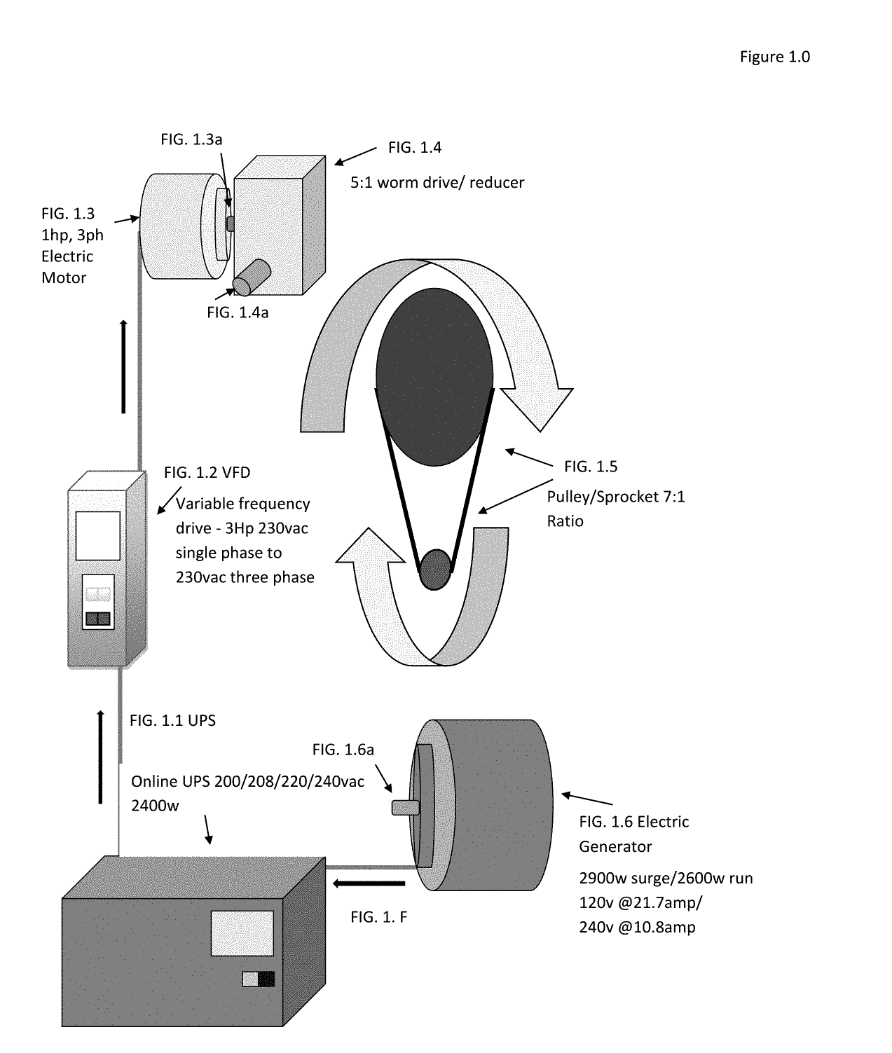

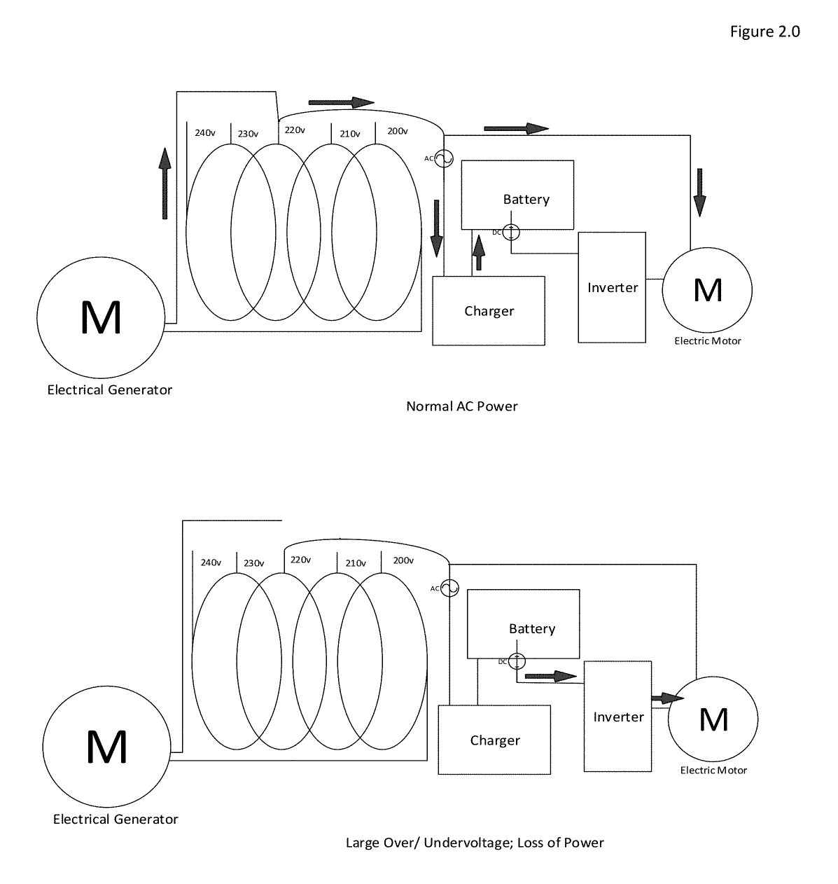

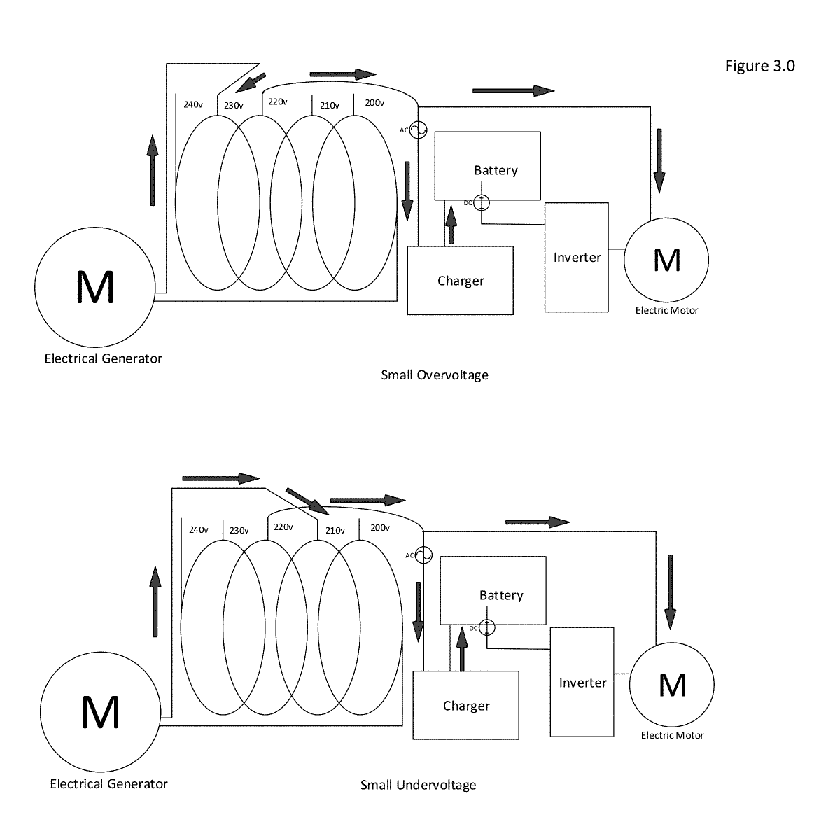

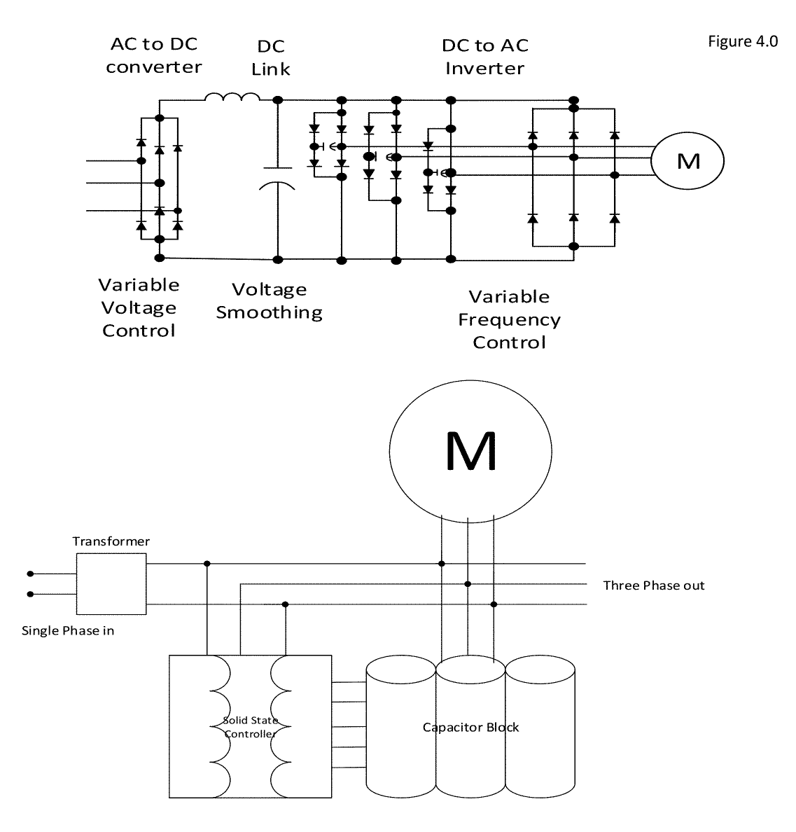

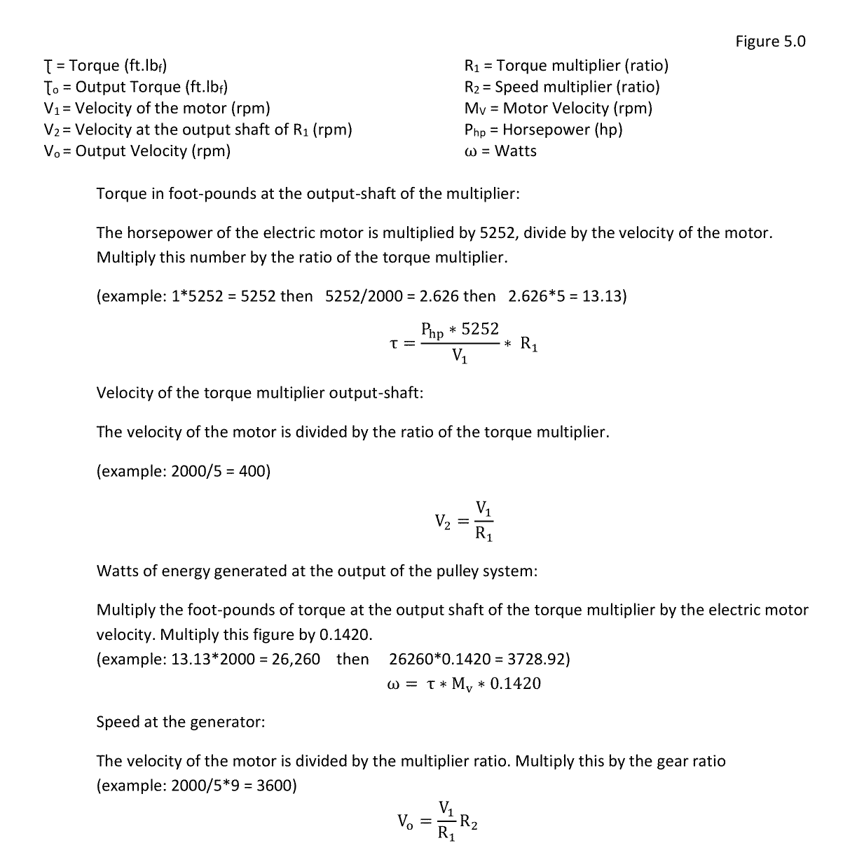

It is to be understood that the drawings (including text) are designed for purposes of illustration only and are not intended for use as a definition of the limits and/or scope of the invention disclosed.

I claim:

1. A electro-mechanical process in which generates electricity to maintain its own functionality in addition to excess energy for external use.

2. Whereas the preferred embodiment of claim 1 consists, generated electricity by utilizing one or more sources of energy as means to supply power to said unit and for additional applications in which the system herein consists of; a power generating method which comprises of at least one or more electrical apparatuses that provide energy to a load, one or more means to raise, lower, or maintain voltage; one or more device(s) that converts electric power provided as single phase to multiple phase or vice-versa, one or more types of motor controller that drives an electric motor by varying the frequency, voltage, hertz, current supplied to the electric motor or any singular action or combination thereof; one or more means to convert electrical energy into mechanical energy, one or more means of applying reduction ratios greater than one to which the given torque at the input gets multiplied as per the reduction ratio and transmitted to the output thereby achieving greater torque but with reduced rotational speed, one or more means to transfer energy by rotational motion, one or more device(s) to convert mechanical energy into electrical energy, insulated conductors used to carry electricity.

3. A electro-mechanical process in which generates electricity by utilizing one or more sources of energy as means to supply power to said unit and for additional applications.

4. Whereas the preferred embodiment of claim 3 consists, generated electricity by utilizing one or more sources of energy as means to supply power to said unit and for additional applications in which the system herein consists of; a power generating method which comprises of at least one electrical apparatus that provide energy to a load, one or more means to raise, lower, or maintain voltage; one or more device(s) that converts electric power provided as single phase to multiple phase or vice-versa, one or more types of motor controller that drives an electric motor by varying the frequency, voltage, hertz, current supplied to the electric motor or any singular action or combination thereof; one or more means to convert electrical energy into mechanical energy, one or more means of applying reduction ratios greater than one to which the given torque at the input gets multiplied as per the reduction ratio and transmitted to the output thereby achieving greater torque but with reduced rotational speed, one or more means to transfer energy by rotational motion, one or more device(s) to convert mechanical energy into electrical energy, insulated conductors used to carry electricity.

5. Whereas the preferred embodiment of claim 3 would imply that when combined in a logical orientation the outcome will provide a continuous supply of energy or intermittent supply of energy dependent upon intention and application.

6. The mechanical and electrical parts in which consists a process that generates electricity by utilizing one or more sources of energy as means to supply power to said unit temporarily or indefinitely for additional applications by which the system herein consists of a power generating method which comprises of at least uninterruptable power supply circuit, a method of converting electrical phase, voltage or hertz and or all three in any sequence; a method for motor control, a electric motor, a gear reduction method, a pulley system, a electric generator, a wiring method to transfer electricity.

7. Whereas the preferred embodiment of claim 6 consists, generated electricity by utilizing one or more sources of energy as a means to supply power to said unit and for additional applications in which the system herein consists of a power generating method which comprises of at least one electrical apparatus that provide energy to a load, at least one means to raise, lower, or maintain voltage singularly or in any combination thereof; at least one device that converts electric power provided as single phase to multiple phase or vice-versa, at least one type of motor controller that controls an electric motor by varying the frequency, voltage, current and or hertz supplied to the electric motor or any singular action or combination thereof; at least one means of converting electrical energy into mechanical energy, at least one means of applying reduction ratios greater than one to which the given torque at the input gets multiplied as per the reduction ratio and transmitted to the output thereby achieving greater torque but with reduced rotational speed, at least one means of transferring energy by rotational motion, at least one device to convert mechanical energy into electrical energy, at least one Insulated conductor used to carry electricity.

8. Whereas the embodiment of claim 6 would imply that when combined in a logical orientation the outcome will provide a continuous supply of energy or intermittent supply of energy dependent upon intention and application.
